(19) United States
(12) Patent Application Publication
(10) Pub. No.: US 2026/0204993 A1
(43) Pub. Date: Jul. 16, 2026

(54) LINEAR VIBRATION MOTOR

(71) Applicant: AAC Microtech (Changzhou) Co., Ltd., Changzhou City (CN)

(72) Inventors: Tong Zhang, Changzhou (CN); Yun Tang, Changzhou (CN); Wei Song, Changzhou (CN)

(21) Appl. No.: 19/304,640

(22) Filed: Aug. 20, 2025

Related U.S. Application Data
(63) Continuation of application No. PCT/CN2025/072727, filed on Jan. 16, 2025.

(51) Int. Cl. H02K 33/02

(52) U.S. Cl. CPC H02K 33/02

(57) ABSTRACT

The present application provides a linear vibration motor including a vibration unit disposed within a housing and an elastic member fixedly connected to the vibration unit and suspending the vibration unit within the housing. The vibration unit includes a mass block fixedly connected to the elastic member, and the elastic member includes an elastic portion connecting two fixing portions. The elastic member includes two elastic arms spaced apart along a first direction. The mass block includes a main body connected to the elastic member and protruding portions extending outward from the side surfaces toward the housing along the vibration direction. The elastic portion and the protruding portions are spaced apart along a second direction perpendicular to both the vibration direction and the first direction. It effectively avoids the issues of oversized structural dimensions and higher risks of plastic deformation while increasing the mass block's volume, thereby enhancing the motor performance.

### CROSS-REFERENCE TO RELATED APPLICATIONS

This application is a continuation of International Application No. PCT/CN2025/072727, filed Jan. 16, 2025, the entire contents of which are incorporated herein by reference.

### TECHNICAL FIELD

The present application relates to the field of linear motors, in particular to a linear vibration motor.

### BACKGROUND

The linear vibration motor in the related art generally includes a housing with an accommodation space, a vibration unit located within the housing, elastic members fixed on both sides of the vibration unit to secure and suspend it within the accommodation space, and a coil fixed to the base. The magnetic field generated by the coil interacts with the magnetic field generated by the vibration unit, thereby driving the vibration unit to perform reciprocating linear motion to generate vibration.

In the related art, the elastic member structure includes a single elastic arm. To meet the performance requirements of a specific resonant frequency for the linear vibration motor, the overall structural dimensions of the elastic member are inevitably larger, making it more prone to plastic deformation. Moreover, when the accommodation space of the linear vibration motor is constrained, the presence of such oversized elastic member structures occupies excessive internal space, thereby limiting the volume of the mass block in the vibration unit and consequently impairing the vibration performance of the linear vibration motor.

Therefore, it is necessary to provide a novel linear vibration motor to resolve the aforementioned issues.

### SUMMARY

The present application provides a linear vibration motor, including:
a housing with an accommodation space;
a vibration unit disposed within the housing;
a coil spaced apart from the vibration unit along a first direction perpendicular to a vibration direction; and
an elastic member fixed to the vibration unit and suspending the vibration unit within the housing;
wherein the housing includes a cover plate spaced apart from the vibration unit, a base fixing the coil, and a side wall connecting the cover plate and the base; the vibration unit includes a mass block fixedly connected to the elastic member and a magnet unit embedded in the mass block; the elastic member includes a first fixing portion fixed to the side wall, a second fixing portion fixed to the mass block, an elastic portion connecting the first fixing portion and the second fixing portion, and two elastic arms spaced apart along the first direction, the elastic arms being V-shaped; the mass block includes a main body fixedly connected to the second fixing portion, which includes a side surface connected to the second fixing portion; the mass block further includes a protruding portion extending outward from the side surface toward the side wall along the vibration direction, and the elastic portion and the protruding portion are spaced apart opposite each other along a second direction perpendicular to both the vibration direction and the first direction.

As an improvement, an orthographic projection of each of the elastic arms along the second direction at least partially overlaps the protruding portion.

As an improvement, each of the elastic arms includes a first elastic arm connected to the first fixing portion, a second elastic arm connected to the second fixing portion, and a bent portion connecting the first elastic arm and the second elastic arm, wherein an opening enclosed by the first elastic arm and the second elastic arm is away from the protruding portion along the second direction.

As an improvement, the side surface includes a first side surface connected to the second fixing portion and a second side surface spaced apart from the elastic portion along the vibration direction, wherein a distance between the second side surface and the side wall along the vibration direction is greater than a distance between the first side surface and the side wall along the vibration direction.

As an improvement, the distance between the second side surface and the side wall along the vibration direction gradually increases from the first side surface toward the protruding portion.

As an improvement, the first fixing portion and the second fixing portion are spaced apart along the vibration direction.

As an improvement, the number of the elastic members is two, and the two elastic members are arranged on opposite sides of the vibration unit along the vibration direction; the number of the protruding portions is two, and the two protruding portions are arranged on opposite sides of the main body along the vibration direction.

As an improvement, the two elastic members are arranged in a center-symmetric manner along a center axis of the mass block parallel to the second direction, the two protruding portions are arranged in a center-symmetric manner along the center axis of the mass block parallel to the second direction, and the protruding portions and the main body are integrally formed.

Compared with the related art, the elastic member in the linear vibrating motor provided by the present application includes a first fixing portion fixed to the side wall, a second fixing portion fixed to the mass block, and an elastic portion connecting the first fixing portion and the second fixing portion. The elastic portion includes two elastic arms spaced apart along the first direction. This effectively reduces the overall structural dimensions of the elastic member while maintaining its stiffness and stress. The mass block further includes protruding portions extending outward from the side surfaces toward the side walls along the vibration direction. The elastic member and the protruding portions are arranged at intervals along a second direction perpendicular to both the vibration direction and the first direction. Since the reduced structural dimensions of the elastic member minimize space occupation, the volume of the mass block is increased, thereby achieving greater vibration amplitude and further enhancing the vibration performance of the linear vibration motor.

### BRIEF DESCRIPTION OF THE DRAWINGS

FIG. 1 is a three-dimensional structural schematic diagram of a linear vibration motor according to an embodiment of the present application.

FIG. 2 is an exploded view of the linear vibration motor in FIG. 1.

FIG. 3 is a sectional view taken along line A-A in FIG. 1.

FIG. 4 is a schematic diagram of a combined structure of a mass block, an elastic member, and a side wall in the linear vibration motor in FIG. 1.

FIG. 5 is a structural schematic diagram of the elastic member of the linear vibration motor shown in FIG. 1.

FIG. 6 is a top view of the combined structure of the mass block, the elastic member, and a base in the linear vibration motor shown in FIG. 1.

FIG. 7 is a front view of the combined structure of the mass block and elastic member in the linear vibration motor shown in FIG. 1.

### DETAILED DESCRIPTION OF THE EMBODIMENTS

To make the objectives, technical solutions, and advantages of the present application clearer, the various embodiments of the present application will be described in detail below with reference to the accompanying drawings. However, those skilled in the art will understand that many technical details have been provided in the various embodiments of the present application to enable readers to better understand the present application. Nevertheless, the technical solutions claimed by the present application can be achieved even without these technical details and various changes and modifications based on the following embodiments.

To further illustrate the various embodiments, the present application provides accompanying drawings. These drawings form part of the disclosure of the present application and are primarily intended to illustrate the embodiments, and may be used in conjunction with the relevant descriptions in the specification to explain the operational principles of the embodiments. With reference to these contents, those skilled in the art should be able to understand other possible embodiments and the advantages of the present application. The components in the drawings are not drawn to scale, and similar component symbols are typically used to represent similar components.

The present application will now be described in further detail with reference to the drawings and embodiments.

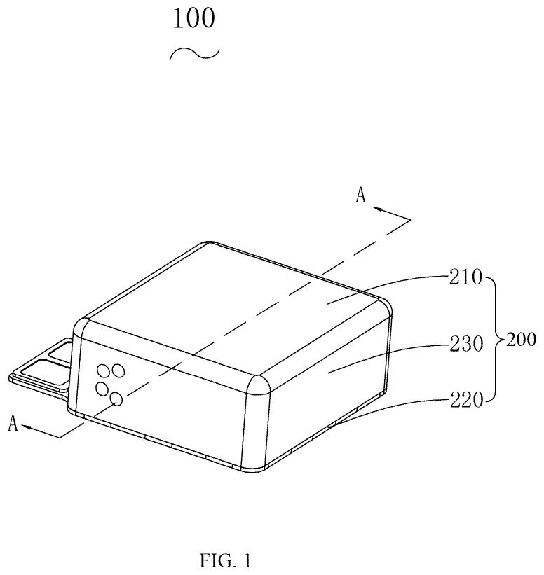

As shown in FIGS. 1, 2, and 3, this embodiment provides a linear vibration motor 100, including a housing 200 with an accommodation space 201, a vibration unit 30 disposed within the housing 200, a coil 40 disposed along a first direction 01 perpendicular to the vibration direction 03 and spaced apart from the vibration unit 30, and an elastic member 70 fixed to the vibration unit 30 and suspending the vibration unit 30 within the housing 200. The housing 200 includes a cover plate 210 spaced apart from the vibration unit 30, a base 220 fixing the coil 40, and a side wall 230 connecting the cover plate 210 and the base 220, which together form the accommodation space 201. In this embodiment, the cover plate 210 and the side wall 230 are square.

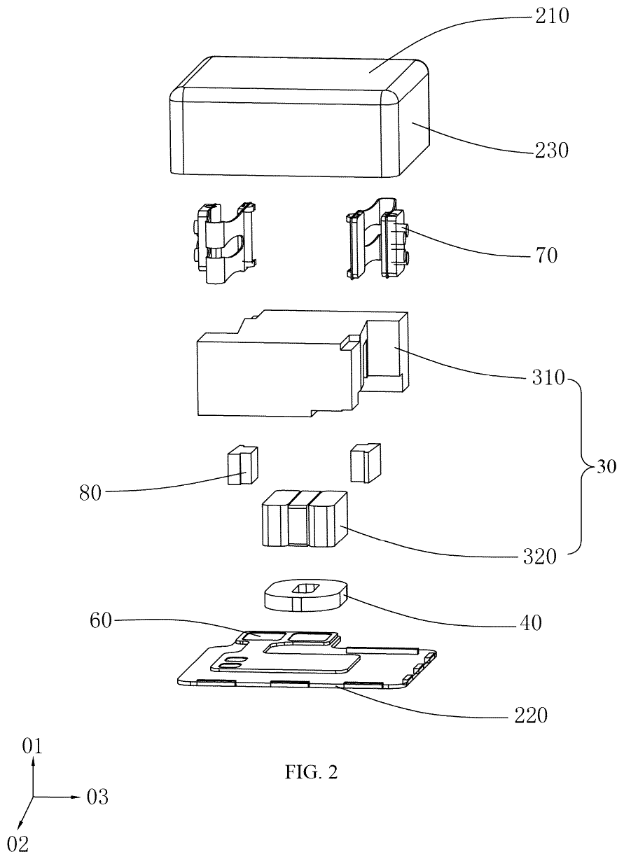

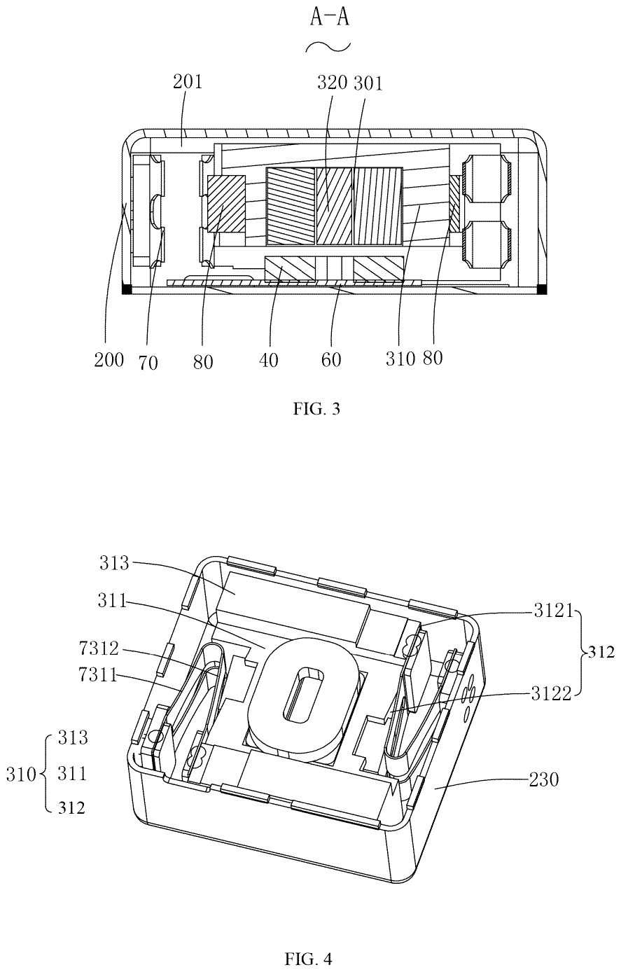

As shown in FIGS. 2 and 3, the vibration unit 30 includes a mass block 310 with an intermediate through hole 301 and a magnet unit 320 assembled within the through hole 301.

As shown in FIGS. 2 and 3, the magnetic field generated by the coil 40 interacts with the magnetic field generated by the magnetic steel unit 320, thereby driving the vibration unit 30 to perform reciprocating linear motion to generate vibration. The linear vibration motor 100 further includes a flexible printed circuit (FPC) board 60 for electrically connecting to the coil 40, and the coil 40 is connected to an external circuit through the FPC board 60 to enable electrical signal input.

As shown in FIGS. 4, 5, and 6, the elastic member 70 provided by the present application includes a first fixing portion 710 fixed to the side wall 230, a second fixing portion 720 fixed to the mass block 310, and an elastic portion 730 connecting the first fixing portion 710 and the second fixing portion 720. The elastic portion 730 includes two elastic arms 731 spaced apart along the first direction 01. The elastic member 70 proposed by an embodiment of the present application has two elastic arms 731. Compared to existing elastic members with only a single elastic arm, this design reduces the structural dimensions of the elastic member 70 while maintaining its overall stiffness and stress, thereby providing more design flexibility for the mass block 310. The number of the elastic members 70 in an embodiment of the present application is two, and they are arranged on opposite sides of the vibration unit 30 along the vibration direction 03. The elastic members 70 drive the vibration unit 30 to vibrate back and forth along the vibration direction 03.

As shown in FIGS. 2, 4, and 6, in this embodiment, the mass block 310 includes a main body 311 located at the center position. The main body 311 includes a side surface 312 connected to the elastic member 70. The mass block 310 further includes a protruding portion 313 extending outward from the side surface 312 toward the side wall 230 of the housing 200 along the vibration direction 03. The protruding portions 313 of the mass block 310 and the elastic portions 730 of the elastic member 70 are spaced apart opposite each other along the second direction 02 perpendicular to both the vibration direction 03 and the first direction 01. Due to the reduced overall dimensions of the elastic member 70, the space occupied by the elastic member 70 within the linear vibration motor 100 is reduced, thereby increasing the volume of the mass block 310 and achieving a larger vibration amplitude, effectively enhancing the vibration performance of the linear vibration motor 100.

The number of protruding portions 313 is two, and the two protruding portions 313 are arranged in a center-symmetric manner along a central axis of the mass block 310 parallel to the second direction 02. The protruding portions 313 and the main body 311 are integrally formed. Therefore, the mass block 310 proposed by the present application has a larger volume compared to the mass blocks in the related art, further improving the performance of the linear vibration motor 100.

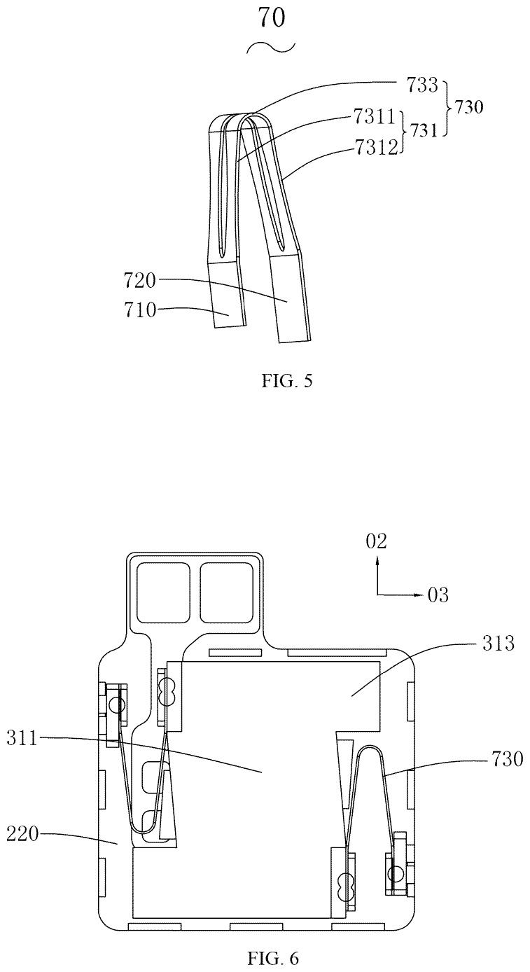

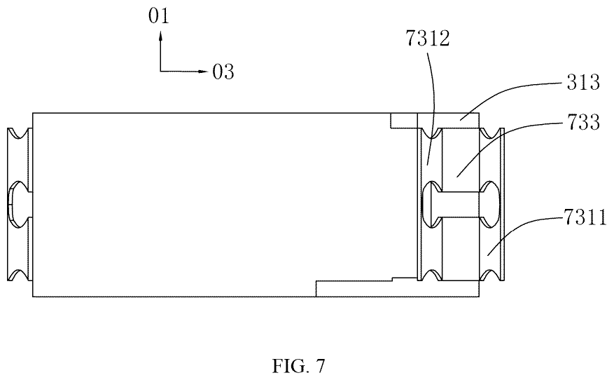

As shown in FIGS. 4, 5, and 6, the side surface 312 of the mass block 310 includes a first side surface 3121 connected to the second fixing portion 720 and a second side surface 3122 spaced apart from the elastic portion 730 along the vibration direction 03. The distance between the second side surface 3122 and the side wall 230 of the housing 200 along the vibration direction 03 is greater than the distance between the first side surface 3122 and the side wall 230 along the vibration direction 03. The distance between the second side surface 3122 and the side wall 230 along the vibration direction 03 gradually increases in the direction from the first side surface 3121 toward the protruding portion. In this embodiment, the elastic arm 731 is V-shaped, and the elastic arm 731 includes a first elastic arm 7311 connected to the first fixing portion 710, a second elastic arm 7312 connected to the second fixing portion 720, and a bent portion 733 connecting the first elastic arm 7311 and the second elastic arm 7312. An opening enclosed by the first elastic arm 7311 and the second elastic arm 7312 is away from the protruding portion 313 along the second direction 02. As shown in FIGS. 5 and 7, an orthographic projection of each of the elastic arms 731 along the second direction 02 at least partially overlaps the protruding portion 313.

As shown in FIG. 2, the linear vibration motor 100 further includes two limiting bosses 80 located on the second side 3122 of the mass block 310. The setting of the limiting bosses 80 prevents the elastic arms 731 of the elastic member 70 from breaking when the amplitude of the vibration unit 30 becomes too large, thereby ensuring the linear vibration motor 100 can function properly and enhancing its stability and reliability. In this embodiment, the limiting bosses 80 are preferably made of damping materials, such as rubber.

Compared with the related art, the elastic member 70 in the linear vibration motor 100 provided by the present application includes a first fixing portion 710 fixed to the side wall 230, a second fixing portion 720 fixed to the mass block 310, and an elastic portion 730 connecting the first fixing portion 710 and the second fixing portion 720. The elastic member 730 includes two elastic arms 731 spaced apart along the first direction 01, effectively reducing the overall structural dimensions of the elastic member 70 while maintaining its stiffness and stress. The mass block 310 further includes protruding portions 313 extending outward from the side surface 312 along the vibration direction 03 toward the side wall 230. The elastic section 730 and the protruding sections 313 are arranged at intervals along the second direction 02, which is perpendicular to the vibration direction 03 and the first direction 01. Since the reduced structural dimensions of the elastic member 70, the volume of the mass block 310 is increased, thereby achieving a larger vibration amplitude and further improving the vibration performance of the linear vibration motor 100.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A linear vibration motor, comprising:
a housing with an accommodation space;
a vibration unit disposed within the housing;
a coil spaced apart from the vibration unit along a first direction perpendicular to a vibration direction; and
an elastic member fixed to the vibration unit and suspending the vibration unit within the housing;
wherein the housing comprises a cover plate spaced apart from the vibration unit, a base fixing the coil, and a side wall connecting the cover plate and the base; the vibration unit comprises a mass block fixedly connected to the elastic member and a magnet unit embedded in the mass block; the elastic member comprises a first fixing portion fixed to the side wall, a second fixing portion fixed to the mass block, an elastic portion connecting the first fixing portion and the second fixing portion, and two elastic arms spaced apart along the first direction, the elastic arms being V-shaped; the mass block comprises a main body fixedly connected to the second fixing portion, which comprises a side surface connected to the second fixing portion; the mass block further comprises a protruding portion extending outward from the side surface toward the side wall along the vibration direction, and the elastic portion and the protruding portion are spaced apart opposite each other along a second direction perpendicular to both the vibration direction and the first direction.

2. The vibration motor of claim 1, wherein an orthographic projection of each of the elastic arms along the second direction at least partially overlaps the protruding portion.

3. The vibration motor of claim 1, wherein each of the elastic arms comprises a first elastic arm connected to the first fixing portion, a second elastic arm connected to the second fixing portion, and a bent portion connecting the first elastic arm and the second elastic arm, wherein an opening enclosed by the first elastic arm and the second elastic arm is away from the protruding portion along the second direction.

4. The vibrating motor of claim 1, wherein the side surface comprises a first side surface connected to the second fixing portion and a second side surface spaced apart from the elastic portion along the vibration direction, wherein a distance between the second side surface and the side wall along the vibration direction is greater than a distance between the first side surface and the side wall along the vibration direction.

5. The vibrating motor of claim 4, wherein the distance between the second side surface and the side wall along the vibration direction gradually increases from the first side surface toward the protruding portion.

6. The vibrating motor of claim 1, wherein the first fixing portion and the second fixing portion are spaced apart along the vibration direction.

7. The vibration motor of claim 1, wherein the number of the elastic members is two, and the two elastic members are arranged on opposite sides of the vibration unit along the vibration direction; the number of the protruding portions is two, and the two protruding portions are arranged on opposite sides of the main body along the vibration direction.

8. The vibration motor of claim 7, wherein the two elastic members are arranged in a center-symmetric manner along a center axis of the mass block parallel to the second direction, the two protruding portions are arranged in a center-symmetric manner along the center axis of the mass block parallel to the second direction, and the protruding portions and the main body are integrally formed.
